(19) United States
(12) Patent Application Publication
(10) Pub. No.: US 2009/0187337 A1
(43) Pub. Date: Jul. 23, 2009

(54) SYSTEM AND METHOD FOR NAVIGATION OF A BUILDING, CAMPUS OR RETAIL STRUCTURE WITH A MOBILE DEVICE

(76) Inventor: William E. DENK, JR., Hanover, PA (US)

Correspondence Address: MCGUIREWOODS, LLP, 1750 TYSONS BLVD, SUITE 1800, MCLEAN, VA, 22102, US

(21) Appl. No.: 12/339,620

(22) Filed: Dec. 19, 2008

Related U.S. Application Data
(60) Provisional application No. 61/014,966, filed on Dec. 19, 2007.

(51) Int. Cl. G01C 21/00

(52) U.S. Cl. 701/201

(57) ABSTRACT

The invention is concerned with a local navigational system, comprising a receiver configured to receive from a requester a request for navigational information to a destination within a facility, a locator configured to determine an initial location of the requester, a data source configured to provide navigational information from the initial location to the destination in response to the request, and a transmitter configured to transmit the navigational information to a requester.

### CROSS REFERENCE TO PRIOR APPLICATIONS

This application claims priority and the benefit thereof from U.S. Provisional Application No. 61/014,966, filed on Dec. 19, 2007, which is hereby incorporated by reference for all purposes as if fully set forth herein.

### FIELD OF THE INVENTION

The invention generally relates to a method, a system and a computer program for providing assistance and/or guidance for navigation of a building, campus, or retail structure through a mobile device. More particularly, the invention relates to a mobile communication system, method, and computer program to facilitate navigation of a campus or facility.

### BACKGROUND OF THE INVENTION

Certain facilities, such as retail centers, theme parks, concert venues, educational campuses, airports, hospitals, hotels, historic districts, and the like, often extend over a wide geographical territory. This is frequently touted as an asset, for example, by marketing that proclaims a facility as “The largest theme park on the East coast!” or “Where the stores are!”

The drawback, though, of such extended geography, is that visitors to the facility may be overwhelmed, misdirected, or even lost within the facility, which may lessen the quality of their visit to the facility. Often, a facility will attempt to remedy this drawback by posting a “You Are Here” map at the entrance to the facility, which may give visitors information and a sense of how to get to their destination within the facility. Additionally, a facility may attempt to remedy this drawback by distributing printed maps of the facility near the entrance.

Such maps, though, whether posted or printed, are insufficient, for several reasons. First, a posted map itself may be difficult to locate, out of date, or congested with other visitors. Second, even after gathering the desired information from a posted map, the visitor may misread, forget, or misremember the information. Third, these maps offer little opportunity for the destinations to promote themselves to the visitors, for example, at a theme park, the operator of the Ferris wheel might like to let visitors know that there is currently no line, or at a shopping mall, the manager of a store might like to let visitors know of a recently arrived product, or a sale on certain items. Fourth, the creation of such posted or printed maps incurs substantial financial cost and environmental waste.

Additionally, as visitors are approaching a facility, they may desire to receive navigation instructions, directions, or guidance to a certain entrance to the facility. For example, when driving to the mall, the visitor may seek the location of the mall entrance that is closest to their destination store; or when driving to an educational campus, the visitor may seek guidance to the parking lot that is closest to the building that houses the physics department. Further, it would be optimal if the visitor could be given information including not only which entrance to head for, and which parking lot to park in, but also the location of an available parking spot nearest their destination within the facility. Toward the end of a visit, visitors may desire to receive navigational instructions from their destination within the facility back to the entrance through which they entered the facility, or even back to their parking spot.

Therefore, what is needed is an interactive way to communicate to visitors directional or navigational information that is easily accessible, easily updateable, mobile, and that does not generate unnecessary paper waste. Additionally, there exists a need for a way to timely communicate to visitors further information, such as special offers, new product arrivals, discounts, and special availability. Further, there exists a need for a way to communicate to visitors information such as a preferred entrance for their desired destination within the facility, and a nearest available parking spot for their preferred entrance to the facility.

### SUMMARY OF THE INVENTION

According to an aspect of the invention, a navigation system is provided that comprises a receiver configured to receive from a requester a request for navigational information to a destination within a facility, a locator configured to determine an initial location of the requestor, a data source configured to provide navigational information from the initial location to the destination in response to the request, and a transmitter configured to transmit the navigational information to a requester.

According to another aspect of the invention, a navigation method is provided that comprises receiving from a requestor a request for navigational information to a destination within a facility, determining an initial location of the requester, accessing navigational information from the initial location to the destination in response to the request, and transmitting the navigational information to the requester.

According to another aspect of the invention, a computer readable medium is provided that includes a computer program, comprising instructions for receiving from a requestor a request for navigational information to a destination within a facility, instructions for determining the initial location of the requester, instructions for navigational information from the initial location to the destination in response to the request, and instructions for transmitting the navigational information to the requestor.

Additional features, advantages, and embodiments of the invention may be set forth or apparent from consideration of the detailed description and drawings. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a system for navigation of a facility, according to an embodiment of the invention;

FIG. 2 shows an example of navigational information available through a mobile device, according to an embodiment of the invention; and

FIG. 3 shows an example of the steps of a method of providing navigational information available through a mobile device, according to an embodiment of the invention.

### DETAILED DESCRIPTION OF THE INVENTION

The advent of the Internet and digital mapping technology has ushered in a whole new way of mapping point-to-point highway destinations. For example, through services such as OnStar®, and web sites such as www.mapquest.com, users may easily access timely and relevant driving directions. Additionally, using mobile devices, mapping point-to-point highway destinations has become much easier, e.g. Google™ maps on the iPhone, Garmin®, and other road mapping devices. However, there is still now way to find point-to-point directions for navigation within facilities such as campus and retail structures.

The present invention takes advantage of the current paper and directory-based mapping of such campuses and buildings, but by using a mobile device and software assists the user to quickly and easily find their current location, and to determine the direction of their destination within the facility.

The embodiments of the invention and the various features and advantageous details thereof are explained more fully with reference to the non-limiting embodiments and examples that are described and/or illustrated in the accompanying drawings and detailed in the following attached description. It should be noted that the features illustrated in the drawings are not necessarily drawn to scale, and features of one embodiment may be employed with other embodiments as the skilled artisan would recognize, even if not explicitly stated herein. Descriptions of well-known components and operating techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention. Moreover, it is noted that like reference numerals represent similar parts throughout the several views of the drawings.

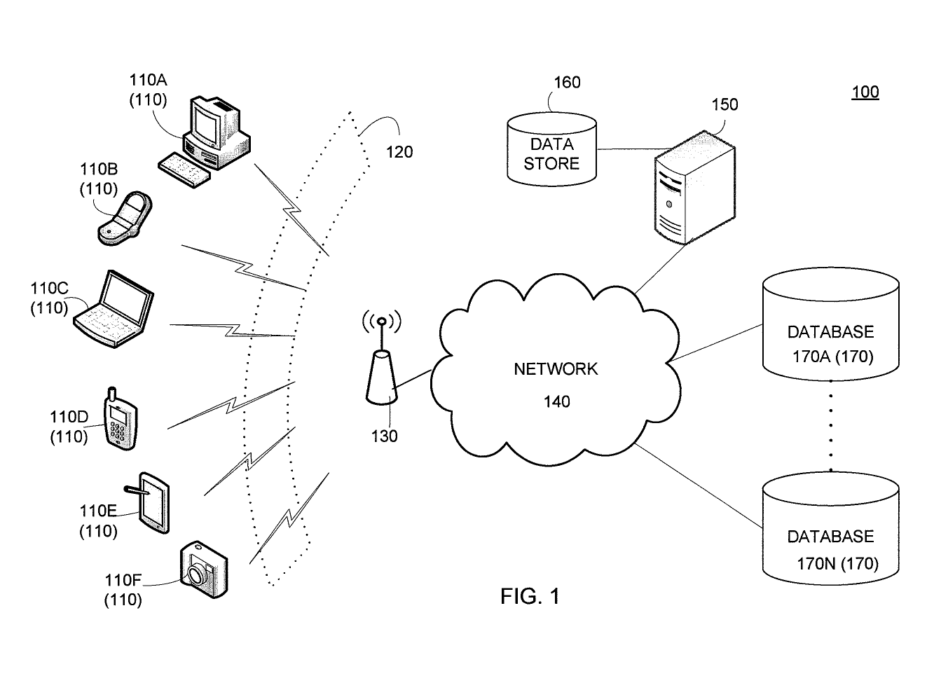

FIG. 1 shows a non-limiting example of a local navigation system 100, according to an embodiment of the invention. The local navigation system 100 includes one or more user interface devices (UIDs) 110 (such as, e.g., a personal computer 110A, a mobile phone 110B, a laptop or notebook computer 110C, a smart phone 110D, a personal data assistant (PDA) 110E, an image pickup device 110F, a software-defined-radio (SDR) (not shown), a two-way radio (not shown), and the like), one or more communication links 120, a communication access point 130, a network 140, a server 150, a data store 160, and one or more databases 170 (such as, e.g., 170A, . . . , 170N, where N is a positive integer greater than one). The one or more UIDs 110 may be coupled to each other or to the network 140 through the communication links 120 and the access point 130. The one or more UIDs 110 may include a positioning capability to determine the actual or approximate position of the UID 110 within a local geographic area. The server 150 and the one or more databases 170 may also be coupled to the network 140. The server 150 may also be coupled to the data store 160.

The various communication links (or connections), including the communication links 120, between the UID(s) 110, access point 130, network 140, server 150, data store 160 and database(s) 170 may include wired or wireless communication media, or any combination of wired or wireless communication media, as is known in the relevant art. The wireless communication links may include, for example, at least one of an IEEE 802.11 standard-compliant link, a DECT standard-compliant link, an 0 G, 1 G, 2 G, 3 G or 4 G cellular standard-compliant link, a Bluetooth compliant link, or the like.

The one or more UIDs 110 may be provided at a same or a different location. Further, the server 150 and the data store 160 may be provided at a same or a different location. Similarly, the one or more databases 170 may be provided at a same or a different location. Moreover, the one or more databases 170 may be provided at the same or different location as the server 150 and/or the data store 160.

A facility may include a physical location, such as, but not limited to, for example, a residence, a school, a workplace, a restaurant, a coffee shop, an airport, a bus terminal, a train station, a stadium, an arena, a concert hall, a boardwalk, or any other private or public location, including a provider location, or any combination of the preceding as will be readily appreciated by those skilled in the art, without departing from the scope or spirit of the invention. Additionally, the user location may include a virtual location, such as, but not limited to, for example, an access point address, a network address, a website address, a telephone number, an email address, a television channel, a television satellite channel, a radio channel, a radio satellite channel, or the like.

It is noted that each of the components 110, 130, 140, 150, 160 or 170 of the local navigation system 100 may include a machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a personal computer, a laptop computer, a palmtop computer, a notebook computer, a desktop computer, a workstation computer, a server, or the like, or an array of processors, microprocessors, central processing units, general purpose computers, personal computers, laptop computers, palmtop computers, notebook computers, desktop computers, workstation computers, servers, or the like.

The access point 130 may include, for example, but is not limited to, a machine, a device, a circuit, a component, or a module, or any system of machines, devices, circuits, components, modules, or the like, which are capable of functioning as a gateway for the one or more UIDs 110 to access the network 140. The access point 130 may include a hot spot such as, for example, a common public application of wireless access points, where the UIDs 110 can connect to each other or to the network 140 through the communication links 120.

The network 140 may include, but is not limited to, for example, any one or more of a personal area network (PAN), a local area network (LAN), a campus area network (CAN), a metropolitan area network (MAN), a wide area network (WAN), a broadband network (BBN), the Internet, or the like. Further, the network 140 may include, but is not limited to, for example, any one or more of the following network topologies, including a bus network, a star network, a ring network, a mesh network, a star-bus network, tree or hierarchical network, or the like.

The server 150 may include, but is not limited to, for example, any combination of software or hardware, including at least one application and/or at least one computer to perform services for connected clients as part of a client-server architecture. The at least one server application may include, but is not limited to, for example, an application program that can accept connections to service requests from clients by sending back responses to the clients. The server 150 may be configured to run the at least one application, often under heavy workloads, unattended, for extended periods of time with minimal or no human direction. The server 150 may include a plurality of computers configured, with the at least one application being divided among the computers depending upon the workload. For example, under light loading, the at least one application can run on a single computer. However, under heavy loading, multiple computers may be required to run the at least one application. The server 150, or any if its computers, may also be used as a workstation.

The data store 160 and the one or more database(s) 170 may include, for example, any combination of software or hardware configured to receive, organize, store, manage, or process data according to a database model, such as, for example but not limited to, a relational model, a hierarchical model, a network model, a post-relational model, an object model, or the like. The database(s) 170 may further include a database management system (DBMS) to organize, store and manage the received data, as well as manage performance, concurrency, integrity, recovery from hardware failures, or the like.

It is noted that the information retrieved from various data sources for a particular facility may be populated in a file or record in the database(s) 170, stored in the data store 160, stored in the server 150, or stored in the UID 110. The information may be automatically forwarded to a particular UID 110 from the server 150 over the network 140 according to, for example, a predetermined schedule, in response to an instruction (e.g., a request, a search, or the like) from the UID 110, according to a user profile stored in the server 150, or the like.

In an embodiment of the invention, navigation information related to a facility may be created in the server 150 and made available to a visitor through an UID 110. The navigation information may be communicated from the server 150 to the UID 110 over the network 140 and loaded into the UID 110.

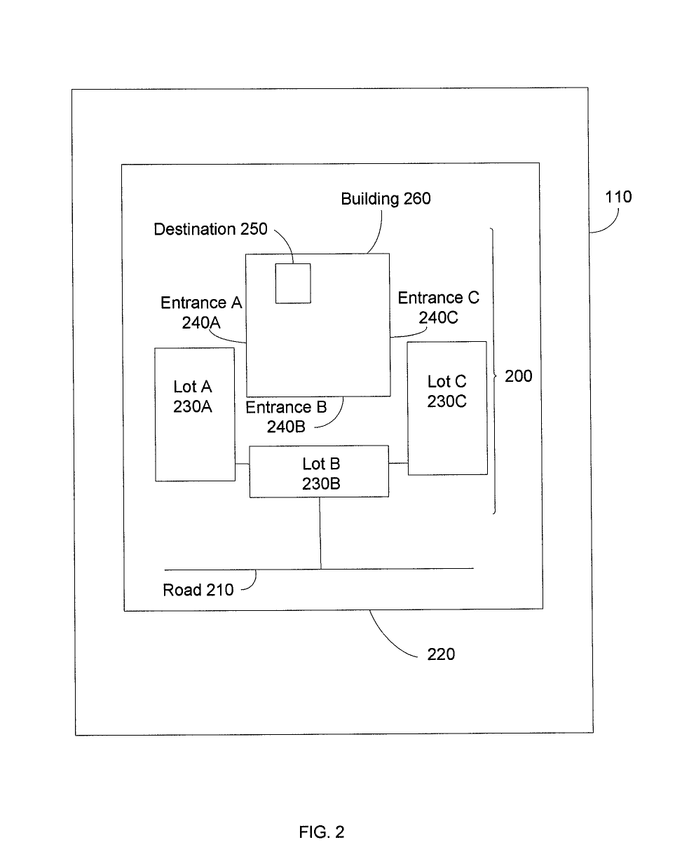

FIG. 2 shows an example of navigational information 220 that may be provided to a visitor through a UID 110 as the individual is approaching or entering the grounds of a facility 200 such as a retail center, theme park, concert venue, educational campus, airport, hospital, hotel, historic district, or the like. As the individual travels along road 210, the individual may send through the UID 110 a request for navigational information 220. The navigational information 220 may then be displayed on the UID 110. The navigational information 220 may include information such as which parking lot 230 or entrance 240 is most convenient to access the individual's destination 250 within the facility 200. The navigational information 220 may include an aerial view or map, as shown in FIG. 2. Alternatively, or in addition, the navigational information may include turn-by-turn directions to the individual. The navigational information may include a street view of the facility, or an internal view of the facility that is analogous to a street view.

In this way, the individual could, for example, determine which entrance 240 is closest to his or her destination 250, which parking lot 230 to park in, and could request detailed instructions to proceed from the individual's present location to reach his or her destination 250.

In an analogous example, in an embodiment, navigational information 220 could be provided to a visitor through a UID 110 as the individual is approaching or entering a building or structure 260 within a facility 200 such as a retail center, theme park, concert venue, educational campus, airport, hospital, hotel, historic district, or the like. In this way, the individual could, for example, determine which direction to turn upon entering entrance A 240A in order to most efficiently reach destination 250.

In either of the above examples, details of the individual's present location could be provided manually by the user, or could be provided automatically by a Global Positioning Satellite System (GPS) or the like.

Further, the present invention may be seamlessly integrated with existing GPS technologies, such as Garmin, such that turn-by-turn directions may be provided on a regional scale through existing technology, and on the local scale through the present invention. In this way, a visitor may receive door-to-door instructions from, for example, his or her home to, for example, a parking spot at a ball game and to, for example, his or her seat in a stadium.

In an embodiment, the system may provide additional communication with visitors to a facility. For example, the system may transmit information regarding sales, promotions, or item or service availability to a visitor upon the visitor's arrival at the facility. When the visitor reaches his or her destination, the visitor may use a code, e-coupon, or other redemption method that was previously transmitted to his or her UID 110.

In an embodiment, the system may provide other special offers to visitors. For example, toward the end of the day, a bakery located within a facility may communicate to visitors that all remaining baked goods are half-priced. Conversely, the system may respond to a visitor's query, providing competitive offers from various vendors. For example, the visitor may inquire regarding the pricing and availability of sweaters, and the system may provide a listing of various stores within the facility that offer sweaters, including what colors and sizes are in stock, and how much each costs.

In an embodiment, the system may provide efficient and orderly directions to a number of destinations within one facility. For example, if a visitor requests directions to three shops within a mall, the system may transmit navigation information directing the visitor to a first destination, then to a second destination, then to a third destination, and finally back to his or her vehicle, offering the quickest or easiest route to each intermediate destination. Additionally, directions to multiple destinations may be ordered taking into account deadlines or closing times. For example, a college student may desire to mail a package from the campus post office, turn in a take home exam, register for next semester's classes, and meet a friend at a coffee shop. Each of these destinations may have a deadline, and the system may organize the navigational information such that each deadline is timely met.

In an embodiment, the system may further provide visitors with mobile purchasing power. In this way, a visitor may remotely place an order and offer a method of payment for an item, and simply arrive at the store to pick up the goods.

In an embodiment, a first visitor may communicate with a second visitor. For example, the first visitor may share his or her map with a second visitor in order to meet at a certain destination, or in order to pass along a recommendation of a restaurant to visit or sight to see. Such communication may include directions, maps, and the like, and may also include photos, comments, menus, or the like.

In an embodiment, the navigational information of the present invention may be provided to fire fighters, or other emergency response personnel, for use in an inspection or in an emergency.

In an embodiment, the navigational information of the present invention may be provided to utility technicians, such as telephone, cable, electrical, or other service providers, for use in installation, repair, or upgrade.

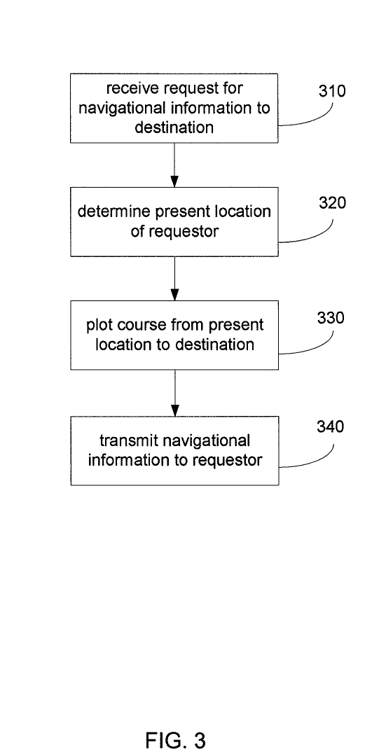

FIG. 3 is a flow diagram showing the steps of a method of providing navigational information to a visitor to a facility, according to an embodiment of the invention. At step 310, the system receives a request for navigational information. This request may be, for example, a request sent by a visitor, through a UID 110, for instructions on how to proceed from an entrance to a facility to a destination within a facility.

At step 320, the present location of the requester is determined, which may be the UID 110. The present location may be determined from the visitor's manual input, or through the use of a GPS system or the like.

At step 330, a course is plotted from the present location to the destination. In order to do so, the system may access one or more databases. The course may be the shortest distance from the initial point to the final point, or may include intermediate points along the route. Alternatively, the course may be the route that best meets certain pre-determined deadlines.

At step 340, navigational information, including the course determined at step 330, is transmitted to the requester. The navigational information may be in a graphical format, such as an aerial view or map, or may be in verbal format, such as giving turn-by-turn directions.

The navigational information may be displayed on, for example, a display included in one or more of the UID(s) 110 shown in FIG. 1. For example, the navigational information may be displayed on the display of a smart phone 110D, such as, for example, but not limited to, an Apple iPhone™, a RIM BlackBerry Storm™, a RIM BlackBerry Bold™, a Palm Treo™, or the like.

Additional information, such as a present location of the UID 110, may be automatically selected (e.g., pre-selection at an OEM, pre-selection on the UID 110 by the visitor, an instruction from the server 150, or the like) or manually selected in the UID 110 by, for example, entering data, using a drop-down menu, or the like. The navigational information 200 stored in the data store 160 and database 170 may be preloaded into the UID 110 (shown in FIG. 1), input into the UID 110, or received by the UID 110 through the communication links 120. The navigational information 200 may be updated in real-time to keep the data current, or may be updated according to a predetermined schedule entered in the UID 110 or the server 150.

Furthermore, links may be uploaded to the UID 110 from the facility or a third party, including a member of the public. The links may include, for example, message links (e.g., blogs, messages, or the like), multimedia links (e.g., website addresses, photos, movies, videos, sound bites, songs, speeches, or the like), merchandising links (e.g., a website address, a telephone number, a physical address, GPS coordinates, a business name, or the like).

It should be noted that the UID 110 may include a machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a personal computer, a laptop computer, a palmtop computer, a notebook computer, a desktop computer, a workstation computer, a server, or the like, or an array of processors, microprocessors, central processing units, general purpose computers, personal computers, laptop computers, palmtop computers, notebook computers, desktop computers, workstation computers, servers, or the like.

Further, communication between the visitor and the UID 110 may be facilitated by the display of one or more selectable links (e.g., thumbnail images, alphanumeric links, or the like) on the display of the UID 110, which the visitor may select by, for example, touching the screen of the UID 110 with a finger, a stylus, a cursor, or the like. Additionally, communication between the visitor and the UID 110 may be facilitated by voice input, or other known communication methods.

According to another aspect of the invention, a computer program is provided, embodied in a computer readable medium. The computer program includes instructions that, when executed on a general purpose computer, cause the computer to carry out the various steps described in FIG. 3. The computer program includes a code section or segment for each of the steps described herein.

While the invention has been described in terms of exemplary embodiments, those skilled in the art will recognize that the invention can be practiced with modifications in the spirit and scope of the appended claims. These examples are merely illustrative and are not meant to be an exhaustive list of all possible designs, embodiments, applications or modifications of the invention.

What is claimed:

1. A local navigational system, comprising:
a receiver configured to receive from a requester a request for navigational information to a destination within a facility;
a locator configured to determine an initial location of the requester;
a data source configured to provide navigational information from the initial location to the destination in response to the request; and
a transmitter configured to transmit the navigational information to a requester.

2. The system according to claim 1, wherein the navigational information includes a plurality of updateable data fields.

3. The system according to claim 2, wherein the plurality of updateable data fields comprises:
a set of turn-by-turn directions from the initial location to the destination,
a street view of the facility;
a pedestrian view of the facility;
an aerial view of the facility; or
a map of the facility.

4. The system according to claim 1, wherein the facility comprises:
a retail center;
a theme park;
a concert venue;
an educational campus;
an airport;
a hospital;
a hotel; or
an historic district.

5. The system according to claim 1, wherein the transmitter transmits to a user interface device.

6. A method for local navigation of a facility, comprising:
receiving from a requestor a request for navigational information to a destination within a facility;
determining an initial location of the requestor;
accessing navigational information from the initial location to the destination in response to the request; and
transmitting the navigational information to the requester.

7. The method according to claim 6, wherein the navigational information includes a plurality of updateable data fields.

8. The method according to claim 7, wherein the plurality of updateable data fields comprises:
a set of turn-by-turn directions from the initial location to the destination;
an aerial view of the facility; or
a map of the facility.

9. The method according to claim 6, wherein the facility comprises:
a retail center;
a theme park;
a concert venue;
an educational campus;
an airport;
a hospital;
a hotel; or
an historic district.

10. The method according to claim 6, wherein the transmitter transmits to a user interface device.

11. A user interface device, comprising:
a transmitter configured to transmit a request for local navigational information to a destination within a facility;
a locator configured to determine an initial location of the user interface device; and
a receiver configured to receive the local navigational information from the initial location to the destination.

12. The device according to claim 11, wherein the navigational information includes a plurality of updateable data fields.

13. The device according to claim 12, wherein the plurality of updateable data fields comprises:
a set of turn-by-turn directions from the initial location to the destination;
an aerial view of the facility; or
a map of the facility.

14. The device according to claim 12, wherein the facility comprises:
a retail center;
a theme park;
a concert venue,
an educational campus;
an airport;
a hospital;
a hotel; or
an historic district.

15. The device according to claim 11, wherein the receiver receives the local navigational information from a local navigational system.

16. A method for local navigation of a facility, comprising:
transmitting a request for local navigation information to a destination within a facility;
determining an initial location from which the request was transmitted; and
receiving the local navigation information from the initial location to the destination.

17. The method according to claim 16, wherein the navigational information includes a plurality of updateable data fields.

18. The method according to claim 17, wherein the plurality of updateable data fields comprises:
a set of turn-by-turn directions from the initial location to the destination;
an aerial view of the facility; or
a map of the facility.

19. The method according to claim 16, wherein the facility comprises:
a retail center;
a theme park;
a concert venue;
an educational campus;
an airport;
a hospital;
a hotel; or
an historic district.

20. A computer readable medium that includes a computer program, comprising:
instructions for receiving from a requester a request for navigational information to a destination within a facility;
instructions for determining the initial location of the requester;
instructions for navigational information from the initial location to the destination in response to the request; and
instructions for transmitting the navigational information to the requester.
